(19) United States
(12) Patent Application Publication
(10) Pub. No.: US 2022/0403868 A1
(43) Pub. Date: Dec. 22, 2022

(54) ROD STRUCTURE USED IN ELECTRONIC DEVICE

(71) Applicant: FIVEGRAND INTERNATIONAL CO., LTD., New Taipei City (TW)

(72) Inventor: TING-JUI WANG, New Taipei City (TW)

(21) Appl. No.: 17/732,567

(22) Filed: Apr. 29, 2022

(30) Foreign Application Priority Data
Jun. 18, 2021 (TW) 110122356

(51) Int. Cl. F16B 21/14; F16B 21/12

(52) U.S. Cl. CPC F16B 21/14; F16B 21/125; G06F 1/183

(57) ABSTRACT

A rod structure is used in an electronic device, the rod structure includes an engaging rod and a fastener. The engaging rod includes a rod. The rod includes an assembly portion and a push portion. The assembly portion is movably assembled at an assembled object, and the push portion is for pushing a pushed object. The fastener is for engaging the engaging rod at an engaged object. When the fastener is engaged with or disengaged from the engaged object, the engaging rod is for causing the push portion to push against the pushed object.

### CROSS-REFERENCE TO RELATED APPLICATION

This non-provisional application claims priority under 35 U.S.C. § 119(a) on Patent Application No(s). 110122356 filed in Taiwan, R.O.C. on Jun. 18, 2021, the entire contents of which are hereby incorporated by reference.

### BACKGROUND OF THE INVENTION

### 1. Field of the Invention

The present disclosure provides a rod structure used in an electronic device, and in particular to a rod structure applied for engaging with or disengaging from an object.

### 2. Description of the Related Art

In general, when two objects are to be coupled, lock connection is usually performed using a screw for coupling the objects.

However, in the conventional connection means above, although the two objects can be coupled in a form that is not easily separated, a situation of timing-consuming and effort-consuming assembly and separation processes may be resulted.

### BRIEF SUMMARY OF THE INVENTION

In view of the issues of the prior art above, in order to overcome these shortcomings, the applicant has dedicated to research and development to provide a rod structure applied in an electronic device in the aim of accomplishing coupling and separation of at least two objects, so as to achieve the objects of repeated quick coupling as well as being time and effort saving.

According to a first aspect of the present disclosure, a rod structure used in an electronic device includes an engaging rod and a fastener. The engaging rod includes a rod. The rod includes an assembly portion and a push portion. The assembly portion is movably assembled at an assembled object, and the push portion is for pushing a pushed object. The fastener is for engaging the engaging rod at an engaged object. When the fastener is engaged with or disengaged from the engaged object, the engaging rod is for causing the push portion to push against the pushed object.

According to a second aspect of the present disclosure, a rod structure used in an electronic device includes the engaging rod and the fastener above. The assembled portion is assembled at the assembled object.

Thus, with the push portion pushing against the pushed object, the rod structure used in an electronic device of the present disclosure can be quickly engaged with or disengaged from an engaged object in a time-saving and effort-saving manner.

### BRIEF DESCRIPTION OF THE DRAWINGS

FIG. 1 is a first top schematic diagram of a rod structure used in an electronic device applied for engaging an object and pushing against another object according to a specific embodiment of the present disclosure.

FIG. 2 is a section schematic diagram corresponding to FIG. 1.

FIG. 3 is a second top schematic diagram of a rod structure used in an electronic device applied for engaging an object and pushing against another object according to a specific embodiment of the present disclosure.

FIG. 4 is a section schematic diagram corresponding to FIG. 3.

FIG. 5 is a first schematic diagram of an operation of a fastener according to a specific embodiment of the present disclosure.

FIG. 6 is a second schematic diagram of an operation of a fastener according to a specific embodiment of the present disclosure.

FIG. 7 is a top schematic diagram of a rod structure used in an electronic device according to a specific embodiment of the present disclosure.

FIG. 8 is a third schematic diagram of an operation of a fastener according to a specific embodiment of the present disclosure.

FIG. 9 is a schematic diagram of an operation of a rod structure used in an electronic device according to a specific embodiment of the present disclosure.

FIG. 10 is a fourth schematic diagram of an operation of a fastener according to a specific embodiment of the present disclosure.

FIG. 11 is a section schematic diagram of a fastener according to a specific embodiment of the present disclosure.

FIG. 12 is a three-dimensional schematic diagram of an engaged object according to a specific embodiment of the present disclosure.

FIG. 13 is a schematic diagram of a state of use of a fastener according to a specific embodiment of the present disclosure.

FIG. 14 is a schematic diagram of a state of use of a fastener according to a specific embodiment of the present disclosure.

FIG. 15 is a first section schematic diagram of a fastener according to a specific embodiment of the present disclosure.

FIG. 16 is a three-dimensional schematic diagram of FIG. 15 installed and applied between a first object and a second object.

FIG. 17A is a schematic diagram of an operation of a neck in FIG. 16 allowing sliding of a second object.

FIG. 17B is a schematic diagram of an engaging head and a body in FIG. 16 fastened at a slide opening of a second object.

FIG. 18 is a second section schematic diagram of a fastener according to a specific embodiment of the present disclosure.

FIG. 19 is a three-dimensional schematic diagram of FIG. 18 installed and applied between a first object and a second object.

FIG. 20A is a schematic diagram of an operation of a neck in FIG. 19 allowing sliding of a second object.

FIG. 20B is a schematic diagram of an engaging head and a body in FIG. 19 fastened at a slide opening of a second object.

FIG. 21 is a third section schematic diagram of a fastener according to a specific embodiment of the present disclosure.

FIG. 22 is a three-dimensional schematic diagram of FIG. 21 installed and applied between a first object and a second object.

FIG. 23A is a schematic diagram of an operation of a neck in FIG. 22 allowing sliding of a second object.

FIG. 23B is a schematic diagram of an engaging head and a body in FIG. 22 fastened at a slide opening of a second object.

FIG. 24A is a schematic diagram of an operation of a neck in FIG. 22 allowing sliding of a second object.

FIG. 24B is a schematic diagram of an operation of a neck in FIG. 22 allowing sliding of a second object.

FIG. 24C is a schematic diagram of an operation of a neck in FIG. 22 allowing sliding of a second object.

FIG. 25 is a section schematic diagram of a neck implemented with a shoulder according to a fourth embodiment of the present disclosure.

FIG. 26 is a section schematic diagram of a colored sleeve implemented according to a preferred embodiment of the present disclosure.

FIG. 27 is a fourth section schematic diagram of a fastener according to a specific embodiment of the present disclosure.

FIG. 28 is a section schematic diagram of FIG. 27 installed and applied between a first object and a second object.

FIG. 29A is a section schematic diagram of a pressing element in FIG. 27 in other preferred embodiments.

FIG. 29B is a section schematic diagram of a pressing element in FIG. 27 in other preferred embodiments.

FIG. 29C is a section schematic diagram of a pressing element in FIG. 27 in other preferred embodiments.

FIG. 29D is a section schematic diagram of a pressing element in FIG. 27 in other preferred embodiments.

FIG. 29E is a section schematic diagram of a pressing element in FIG. 27 in other preferred embodiments.

FIG. 30 is a section schematic diagram of an application of a fastener according to a specific embodiment of the present disclosure.

FIG. 31 is a fifth section schematic diagram of a fastener according to a specific embodiment of the present disclosure.

FIG. 32 is a sixth section schematic diagram of a fastener according to a specific embodiment of the present disclosure.

FIG. 33 is a section schematic diagram of an elastic element being directly fastened according to a specific embodiment of the present disclosure.

FIG. 34 is a section schematic diagram of a neck and a body formed as an integral.

FIG. 35 is a section schematic diagram of a neck fixed at a first object by a connecting member.

FIG. 36 is a section schematic diagram of a neck formed as an integral at a first object.

FIG. 37 is a first section schematic diagram of an elastic element in FIG. 33 in another preferred embodiment.

FIG. 38A is a second section schematic diagram of an elastic element in FIG. 33 in other preferred embodiments.

FIG. 38B is a second section schematic diagram of an elastic element in FIG. 33 in other preferred embodiments.

FIG. 38C is a second section schematic diagram of an elastic element in FIG. 33 in other preferred embodiments.

FIG. 38D is a second section schematic diagram of an elastic element in FIG. 33 in other preferred embodiments.

FIG. 38E is a second section schematic diagram of an elastic element in FIG. 33 in other preferred embodiments.

FIG. 38F is a second section schematic diagram of an elastic element in FIG. 33 in other preferred embodiments.

FIG. 38G is a second section schematic diagram of an elastic element in FIG. 33 in other preferred embodiments.

FIG. 38H is a second section schematic diagram of an elastic element in FIG. 33 in other preferred embodiments.

FIG. 39 is a schematic diagram of an elastic element provided with a combination of a notch and a neck.

FIG. 40 is a section schematic diagram of a neck provided on one end with a second shoulder pressing against an elastic element.

FIG. 41 is a section schematic diagram of a state of an elastic element in FIG. 40 pressing a second object.

FIG. 42 is a section schematic diagram of a neck provided on one other end with a second shoulder pressing against an elastic element.

FIG. 43 is a section schematic diagram of a state of an elastic element in FIG. 42 pressing a second object.

FIG. 44 is a schematic diagram of a neck and a body assembled by a screw structure.

FIG. 45 is a schematic diagram of a neck and an engaging head assembled by a screw structure.

FIG. 46 is a schematic diagram of a neck provided with a first stop portion and a second stop portion and a sliding and engaging operation thereof.

FIG. 47 is a three-dimensional schematic diagram of a slide opening of a second object according to another embodiment.

FIG. 48 is a schematic diagram of a body implemented with a first stop portion and a second stop portion and a sliding and engaging operation thereof.

### DETAILED DESCRIPTION OF THE INVENTION

To facilitate understanding of the object, characteristics and effects of this present disclosure, embodiments together with the attached drawings for the detailed description of the present disclosure are provided.

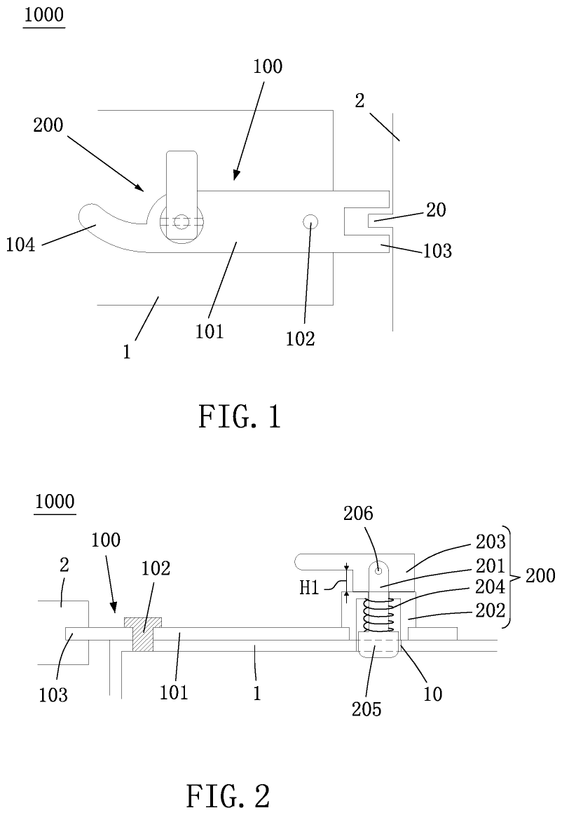

Referring to FIG. 1 to FIG. 4, a rod structure 1000 used in an electronic device is provided according to a first embodiment of the present disclosure. The rod structure 1000 includes an engaging rod 100 and a fastener 200. The engaging rod 100 includes a rod 101. The rod 101 includes an assembly portion 102 and a push portion 103. The assembly portion 102 s movably assembled at an assembled object such as an object 1, and the push portion 103 is for pushing a pushed object 2. The fastener 102 is for engaging the engaging rod 100 at an engaged object such as the object 1. When the fastener 200 is used for engaging with or disengaging from the fastened object such as the object 1, the engaging rod 100 is for causing the push portion 103 to push against the pushed object 2. For example, the engaging rod 100 may cause the push portion 103 to push against the pushed object 2 by movement of the object 1 (for example, movement of the assembly portion 102 relative to the object 1), so as to provide additional force assisting the engaging or disengaging. The object 1 (the engaged object or the assembled object) or the pushed object 2 is a data center cabinet, a server, a memory, a motherboard, a circuit board, a heat sink, a chassis, a casing, a plate, a hard drive or a shell. It should be noted that the present disclosure is not limited to the examples above. In this embodiment, the engaged object and the assembled object may be the same object 1, or may be two different objects.

A second embodiment of the present disclosure may include only the engaging rod 100 and the fastener 200. The engaging rod 100 is movably assembled or fixedly assembled at an assembled object such as the object 1.

As described above, with the push portion 103 pushing against the pushed object 2, the rod structure 1000 used in an electronic device of the present disclosure can be quickly engaged with or disengaged from an engaged object such as the object 1 in a time-saving and effort-saving manner.

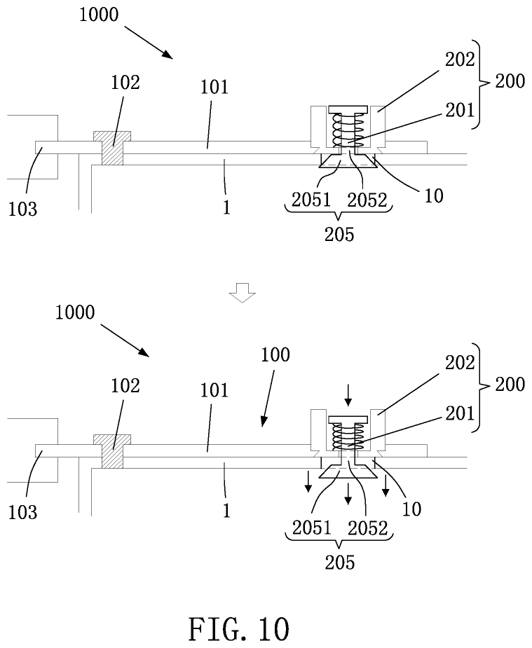

As shown in FIG. 2, FIG. 4 and FIG. 10, in one embodiment, the fastener 200 includes a fastening portion 201, a body 202 and a trigger portion 203. The fastening portion 201 is for engaging at a counterpart engaging portion 10 of an engaged object such as the object 1. An assembly portion of the body 202 is for assembling at the rod 101 of the engaging rod 100. The trigger portion 203 is located at the body 202, for example, a top end of the body 202. The fastening portion 201 passes through the body 202 and is movably assembled at the trigger portion 203. The trigger portion 203 is for being triggered so as to prompt the fastening portion 201 to move up and down in the body 202. The fastener 200 may further include an elastic element 204. The elastic element 204 is provided between the fastening portion 201 and the body 202. The trigger portion 203 is for being triggered to prompt the fastening portion 201 to be elastically moved in the body 202. The fastening portion 201 may include a head 205. The head 205 is for elastically sandwiching or engaging the counterpart engaging portion 10 via an elastic force of the elastic element 204. For example, in FIG. 10, the head 205 may have a trapezoidal cross section.

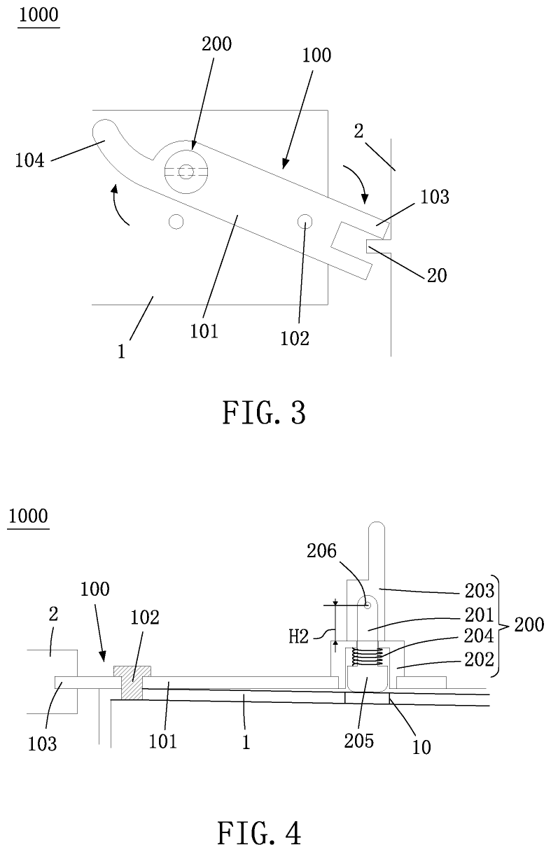

As shown in FIG. 1 to FIG. 4, in one embodiment, the movable assembly between the trigger portion 203 and the engaging portion 201 may be a pivotal connection, and the trigger portion 203 is for being triggered between an engaging state (as shown in FIG. 1 and FIG. 2) and a lifted state (as shown in FIG. 3 and FIG. 4). In the engaging state, the engaging portion 201 is engaged at the counterpart engaging portion 10 of the object 1, and the trigger portion 203 is movably assembled at an engaging height H1 between a pivotal portion 206 of the engaging portion and the body 202. In the lifted state, the engaging portion 201 is disengaged from the counterpart engaging portion 10 of the object 1, and the pivotal portion 206 of the trigger portion 203 and the body 202 have a lifted height H2 in between, wherein the lifted height H2 is greater than the engaging height H1. Moreover, the trigger portion 203 lifts or presses down the engaging portion 201 by means of rotating pivotally so as to convert between the engaging state and the left state, thereby performing an effort-saving pressing motion between high and low positions. The engaging rod 100 has an operating portion 104. The operating portion 104 is provided at the rod 101 on one end away from the push portion 103 so as to facilitate the operation of a user. The operating portion 104 is, for example but not limited to, an extension pin. The push portion 103 may be a hold portion, and the pushed object 2 may have a pushed portion 20 such as a protrusion; however, the present disclosure is not limited to the examples above.

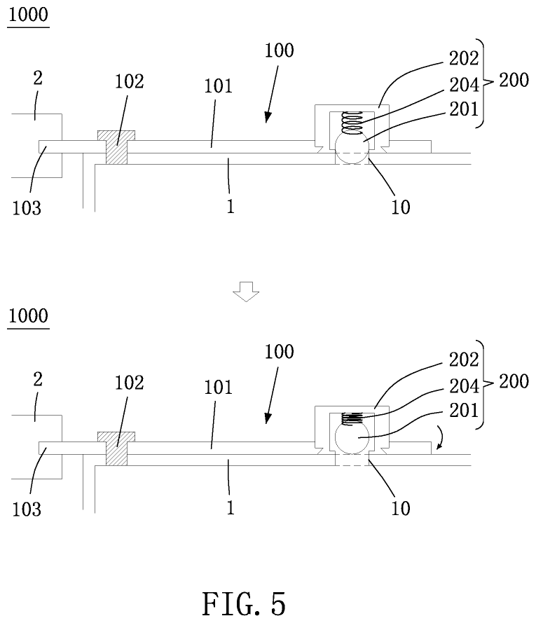

As shown in FIG. 5, in one embodiment, the fastener 200 includes an engaging portion 201, a body 202 and an elastic element 204. The engaging portion 201 is for engaging at the counterpart engaging portion 10 of the object 1. The body 202 is for assembling at the rod 101 of the engaging rod 100. The elastic element 204 is provided between the engaging portion 201 and the body 202. The engaging portion 201 is a sphere and is rotated and received in the counterpart engaging portion 10 of the object 1 via an elastic force of the elastic element 204.

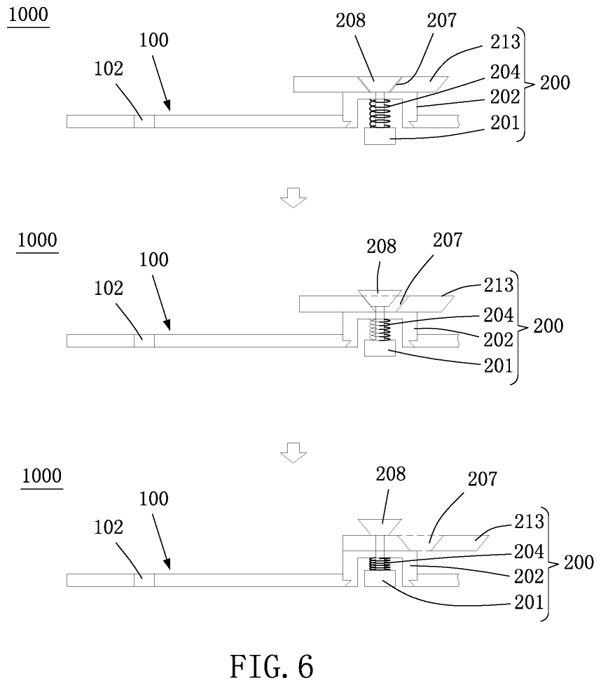

As shown in FIG. 6, in one embodiment, the fastener 200 includes an actuating member 213, an engaging portion 201, a body 202 and an elastic element 204. The actuating member 213 includes, for example, a slide portion 207 having a through slot with a sloped surface. The engaging portion 201 has a corresponding slide portion 208 corresponding to the slide portion 207, wherein the corresponding slide portion 208 is, for example, a slide block. The elastic element 204 is provided between the engaging portion 201 and the body 202. The actuating member 213 is for being moved to prompt the corresponding slide portion 208 to slide relative to the slide portion 207, so as to elastically move the engaging portion 201 using the elastic force of the elastic element 204. It should be noted that, in some embodiments, the elastic element 204 may also be omitted, provided that the actuating member 213 can be moved to prompt the corresponding slide portion 208 to slide relative to the slide portion 207 so as to move the engaging portion 201.

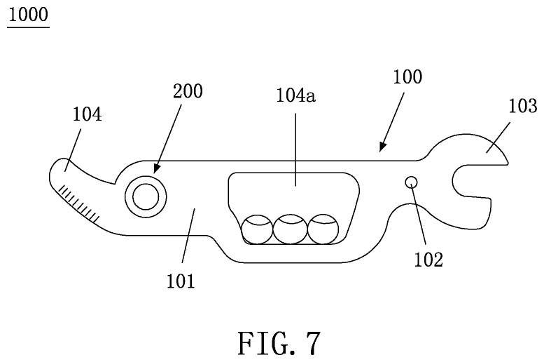

As shown in FIG. 7, the engaging rod 100 includes an operating portion 104a. The operating portion 104a is provided between the fastener 200 and the assembly portion 102, and specifically, the operating portion 104a may be an opening provided between the fastener 200 and the assembly portion 102 for holding of a finger. In this embodiment, the operating portion 104 in FIG. 1 may also be provided on one end of the rod 101.

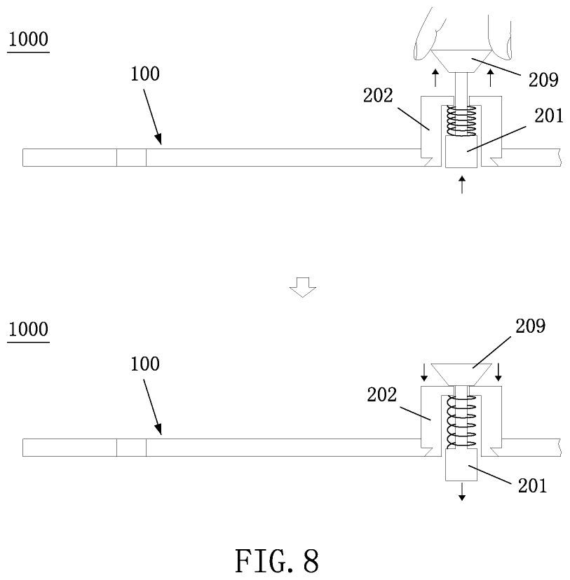

Referring to FIG. 8 as well as FIG. 1, in one embodiment, the engaging portion 201 includes a manual control portion 209 for holding and operation of a hand. For example, a main body of the engaging portion 201 may pass through the body 202 and be engaged with the counterpart engaging portion 10 of the object 1, and the manual control portion 209 is connected to the main body of the engaging portion 201, is located on a top end of the body 202, and is tapered in a downward direction, such that the engaging portion 201 can be received in the counterpart engaging portion 10 of the object 1 by operating the manual control portion 209. According to the form of the engaging portion 201 and the counterpart engaging portion 10, the engaging portion 201 can be operated so as to be engaged with or disengaged from the counterpart engaging portion 10 by moving the manual control portion 209 up and down and/or rotating the manual control portion 209.

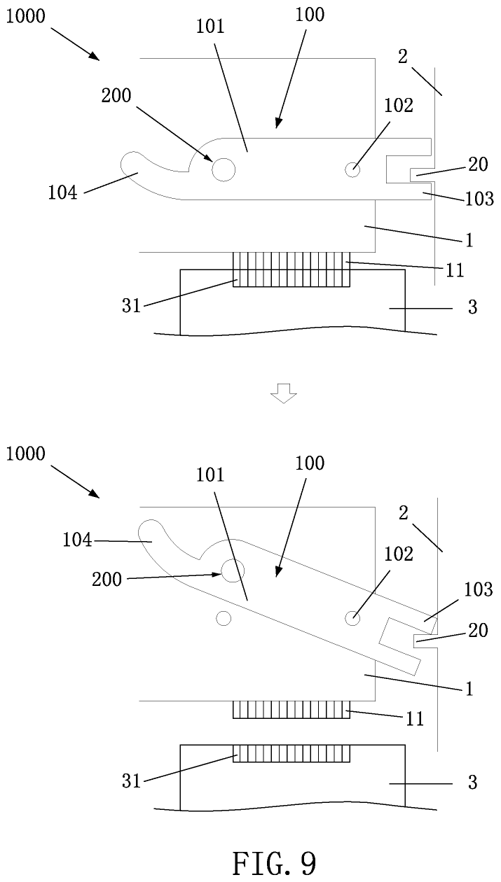

As shown in FIG. 9, in one embodiment, a first connector 11 is provided on one side of the object 1, the push portion 103 pushes the pushed object 2 so as to prompt the fastener 200 to be engaged at an assembled object such as the object 1 and to move the object 1 toward a connected object 3, so that the first connector 11 is connected to a second connector 31 of the connected object 3. Alternatively, the pushed portion 103 pushes the pushed object 2 so as to disengage the fastener 200 from the object 1 and to prompt the object 1 to move away from the connected object 3, so that the first connector 11 departs from the second connector 31.

As shown in FIG. 10, in one embodiment, the fastener 200 includes a head 205. The head 205 includes a shaft 2052 and an assembly portion 2051. The assembly portion 2051 is, for example, integrally connected to the shaft 2052. The width of the assembly portion 2051 may be greater than that of the counterpart engaging portion 10, and the width of the shaft 2052 may be smaller than that of the counterpart engaging portion 10, so that the shaft 2052 can enter the counterpart engaging portion 10 to engage the assembly portion 2051 at the counterpart engaging portion 10.

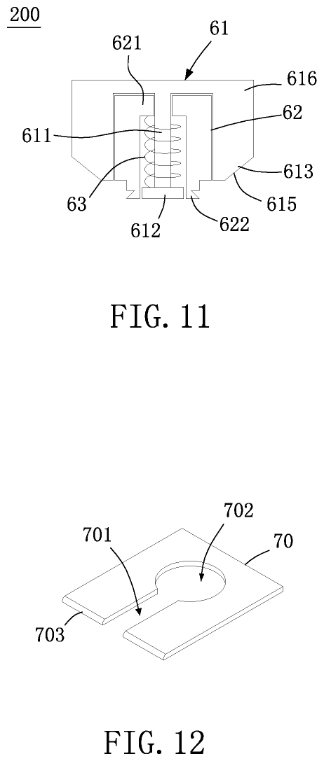

Referring to FIG. 11 to FIG. 13, as shown in the drawings, the fastener 200 may include a head 61, a body 62 and an elastic element 63. The head 61 includes a shaft 611, a stop portion 612 and a fitting portion 613 (or the fitting portion is excluded). The body 62 includes a corresponding stop portion 621, and the corresponding stop portion 621 is movably assembled with the stop portion 612. The elastic element 63 has one end pressing against the stop portion 612, and the other end pressing against the body 62, so that the head 61 can move elastically.

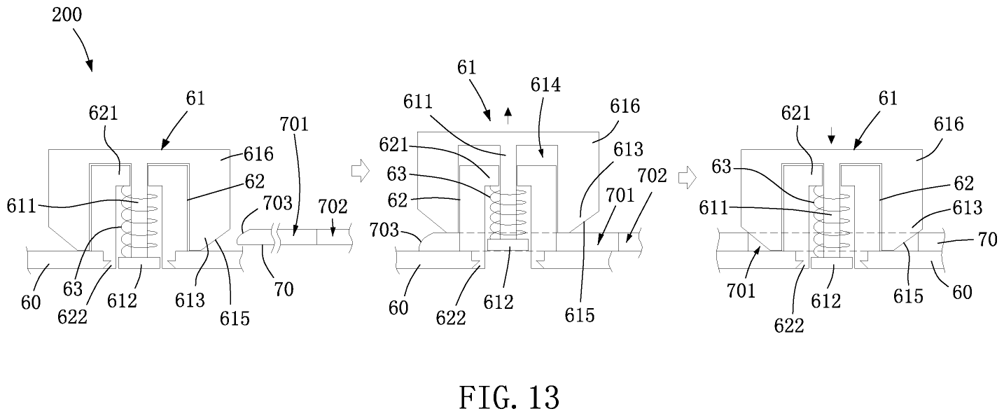

As shown in FIG. 11 and FIG. 13, to put to use, the body 62 may be assembled at an object 60. The object 60 is equivalent to the engaging rod 100 in FIG. 1, and is capable of causing the fitting portion 613 of the head 61 to be engaged at a receiving portion 701 of an engaged object 70 (equivalent to the object 1 in FIG. 1), compressing the elastic element 63, and then being engaged at an engaging portion 702 (equivalent to the counterpart engaging portion 10 in FIG. 2) of the engaged object 70, such that the elastic element 63 is released and the head 61 is elastically engaged at the engaged object 70 via the fitting portion 613. To remove the engaged object 70, the head 61 may be pulled to allow the fitting portion 613 to depart from the engaging portion 702 and compress the elastic element 63, and the engaged object 70 is then moved in reverse to release the elastic element 63, so that the head 61 is reset for the next use. Thus, the fitting portion 613 of the head 61 can be elastically engaged at the engaged object 70 or be removed from the engaged object 70, so as to complete coupling and separation of at least two objects, thereby achieving the effect of repeated quick coupling and separation.

As shown in FIG. 11 to FIG. 13, in one embodiment, the body 62 includes an assembly portion 622, and the body 62 can be stably assembled at the object 60 via the assembly portion 622, thus facilitating engaging of the head 61 and the engaged object 70.

As shown in FIG. 11 to FIG. 13, in one embodiment, the head 61 further includes an accommodating portion 614, and the body 62 is accommodated in the accommodating portion 614. Thus, the height of the fastener 200 is reduced so that the present disclosure better satisfies actual application requirements.

As shown in FIG. 11 to FIG. 13, in one embodiment, the fitting portion 613 is a sloped surface, a curved surface, an arched surface or a stepped portion, and is for first being received in the receiving portion 701 of the engaged object 70, and then engaged at the engaging portion 702 of the engaged object 70, so that the head 61 is elastically engaged at the engaged object 70 via the fitting portion 613 to complete coupling of at least two objects.

As shown in FIG. 11 to FIG. 13, in one embodiment, the width of the fitting portion 613 is greater than that of the receiving portion 701 of the engaged object 70, and the width of the body 62 is smaller than that of the receiving portion 701, so that the fitting portion 613 is first fitted at the receiving portion 701 and then engaged at the engaging portion 702 of the engaged object 70, and the head 61 is elastically engaged at the engaged object 70 via the fitting portion 613, thus completing coupling of at least two objects.

As shown in FIG. 11 to FIG. 13, in one embodiment, the fitting portion 613 includes a guide portion 615. The guide portion 615 may be a sloped surface, a curved surface, an arched surface, a stepped portion or a tiered portion (implemented as a slope surface in the present disclosure), and is capable of guiding by a slope surface and pushing the head 61 to enter the receiving portion 701 of the engaged object 70 and then being engaged at the engaging portion 702 of the engaged object 70. The guide portion 615 entered the engaging portion 702 may apply a force on the object 60, such that the guide portion 615 lifts by an inclined surface the head 61 to remove the fitting portion 613 from the engaging portion 702 and then enter the receiving portion 701 so as to depart from the engaged object 70, thus completing separation of at least two objects.

As shown in FIG. 11 to FIG. 13, in one embodiment, the fitting portion 613 can be received in a corresponding guide portion 703 of the engaged object 70, and the corresponding guide portion 703 may be an inclined surface, an arched surface, a curved surface, a stepped surface or a planar surface (implemented as an arched surface in the present disclosure). For engaging, the corresponding guide portion 703 of the engaged object 70 is caused to push the guide portion 615, such that the fitting portion 613 of the head 61 is elastically engaged at the receiving portion 701 of the engaged object 70, compresses the elastic element 63 and is engaged at the engaging portion 702 of the engaged object 70, the elastic element 63 becomes released, and the head 61 is caused to be elastically engaged at the engaged object 70 via the fitting portion 613, thus completing coupling of at least two objects.

As shown in FIGS. 11 to 13, in one embodiment, the head 61 includes a pull-up portion 616. To remove the engaged object 70, the pull-up portion 616 of the head 61 is pulled so that the fitting portion 613 departs from the engaging portion 702 and compresses the elastic element 63, and the engaged object 70 is then moved in reverse to release the elastic element 63, so as to reset the head 61 for the next use. Thus, the fitting portion 613 of the head 61 elastically engaged can be removed from the engaged object 70, thus completing separation of at least two objects.

As shown in FIGS. 11 to 13, in one embodiment, the elastic element 63 has one end pressing against the stop portion 612, and the other end pressing against the corresponding stop portion 621 of the body 62, such that the head 61 moves and drives the shaft 611 to move elastically in the body 62 to compress the elastic element 63 or release the elastic element 63, so as to reset the head 61 for the next use.

As shown in FIG. 11 to FIG. 13, in a preferred specific embodiment of the present disclosure, the shaft 611 and the head 61 are in a mobile assembly, a fixed assembly, a combined assembly or an integral, allowing the present disclosure to adapt to different application conditions and requirements.

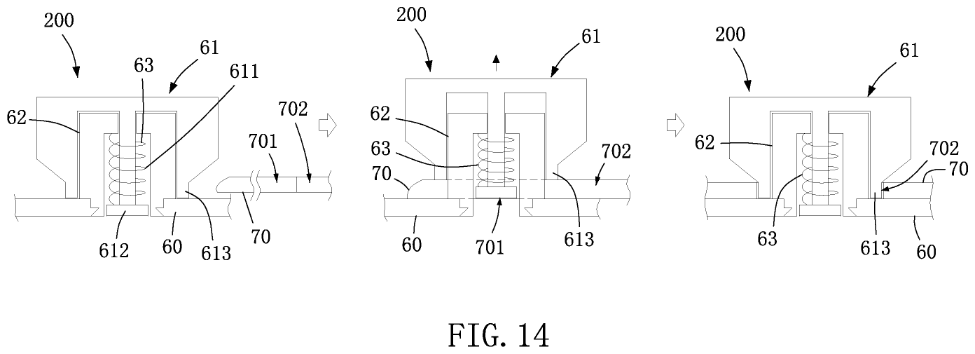

Referring to FIG. 14, in one embodiment, the fitting portion 613 is a fixed limiting portion for passing through above the receiving portion 701 of the engaged object 70, compressing the elastic element 63 and then being engaged at the engaging portion 702 of the engaged object 70, such that the elastic element 63 is released and the fitting portion 613 fixedly stops and limits the engaging portion 702. To remove the engaged object 70, the head 61 is pulled so that the fitting portion 613 departs from the engaging portion 702 and compresses the elastic element 63, and the engaged object 70 is then moved in reverse to release the elastic element 63, so as to reset the head 61 for the next use. Thus, the fitting portion 613 of the head 61 can be elastically engaged at the engaged object 70 or be removed from the engaged object 70, allowing the fastener 200 to complete coupling and separation of at least two objects (the object 60 and the engaged object 70), thereby achieving the effect of repeated quick coupling and separation.

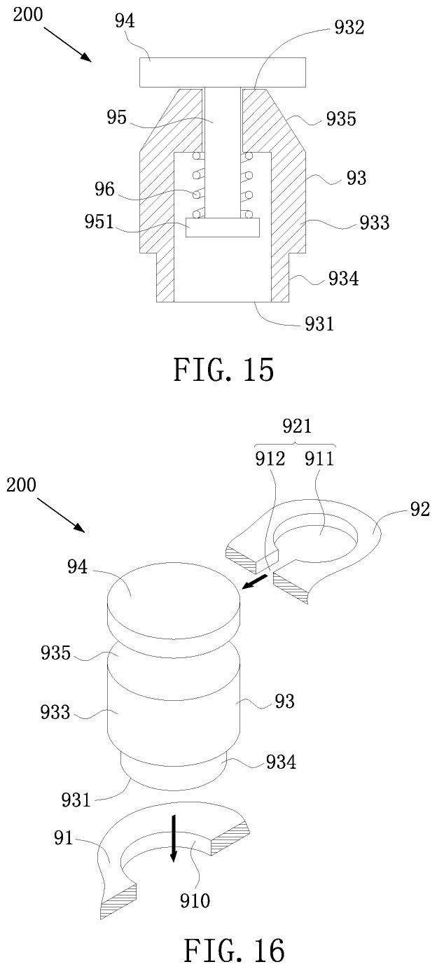

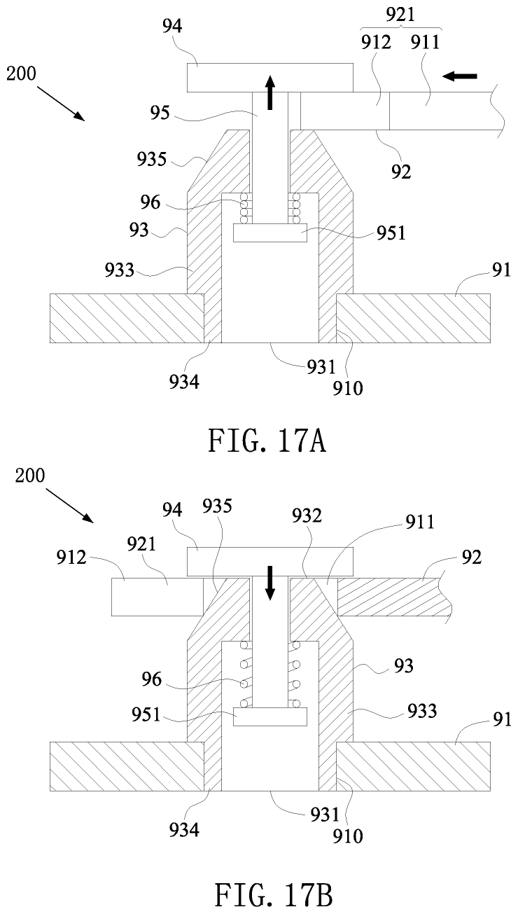

Referring to FIG. 15 and FIG. 16, one end of the fastener 200 may be coupled to a first object 91 (for example, an object such as a circuit board, a substrate, a chassis or the object 1 in FIG. 1), and the other end may slide on a second object 92 (for example, an object such as a circuit board, a substrate, a chassis or the engaging rod 100 in FIG. 1) and further be positioned and fastened at a column structure in a slide opening 921 of the second object 92 once having slid to a predetermined position. In a preferred specific embodiment, the fastener 200 includes: a body 93, a first end 931 of the body 93 being integrally formed or assembled on the first object 91; an engaging head 94 movably disposed on a second end 932 of the body 93, the engaging head 94 having a neck 95, the neck 95 movably disposed at the body 93 or movably disposed at the body 93 and not being exposed outside the first end 931 of the body 93 or outside the first object 91, so that the neck 95 is for moving in the slide opening 921 of the second object 92; and an elastic element 96, the elastic element 96 movably disposed around the neck 95 such that one end of the elastic element 96 presses against the body 93 and the other end presses against a stop portion 951 on one end of the neck 95, wherein the stop portion 951 is a disk, a ring, a block or a plate greater than the neck 95, and the stop portion 951 and the neck 95 may be formed as an integral or formed as an assembly. Moreover, as shown in FIG. 15 and FIG. 17A, when the body 93 is coupled on the first object 91, the neck 95 is movable in the slide opening 921 of the second object 92. Once the neck 95 moves to a predetermined position, as shown in FIG. 17B, with the effect of the elastic element 96, the engaging head 94 and the body 93 can be fastened in the slide opening 921 of the second object 92, further forming a structure for engaging the second object 92 and providing shock absorption.

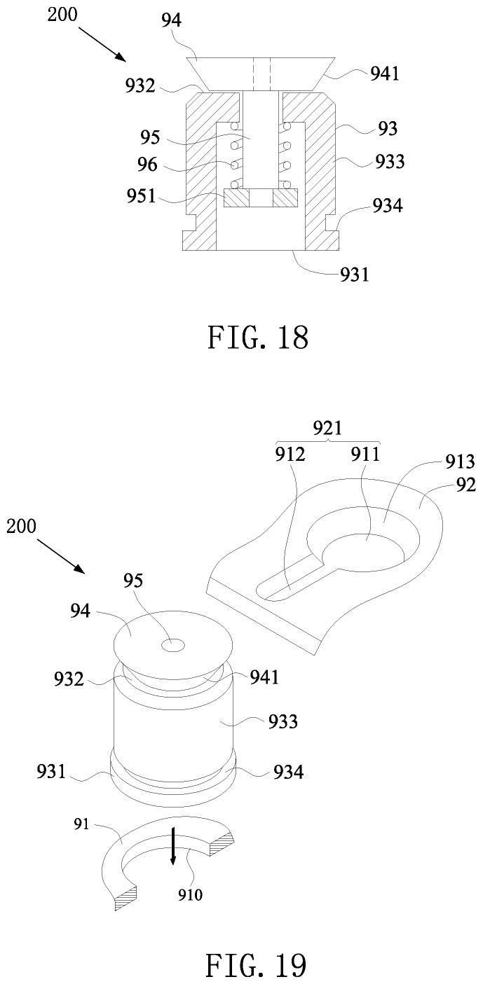

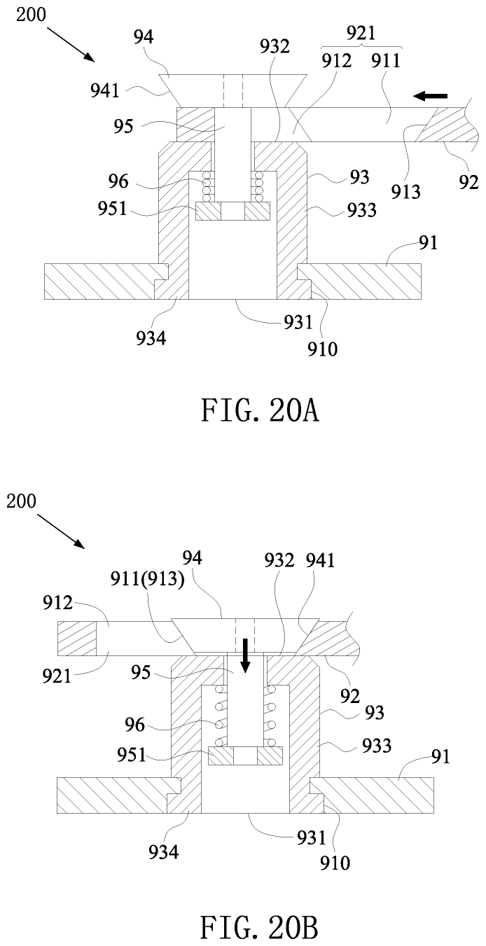

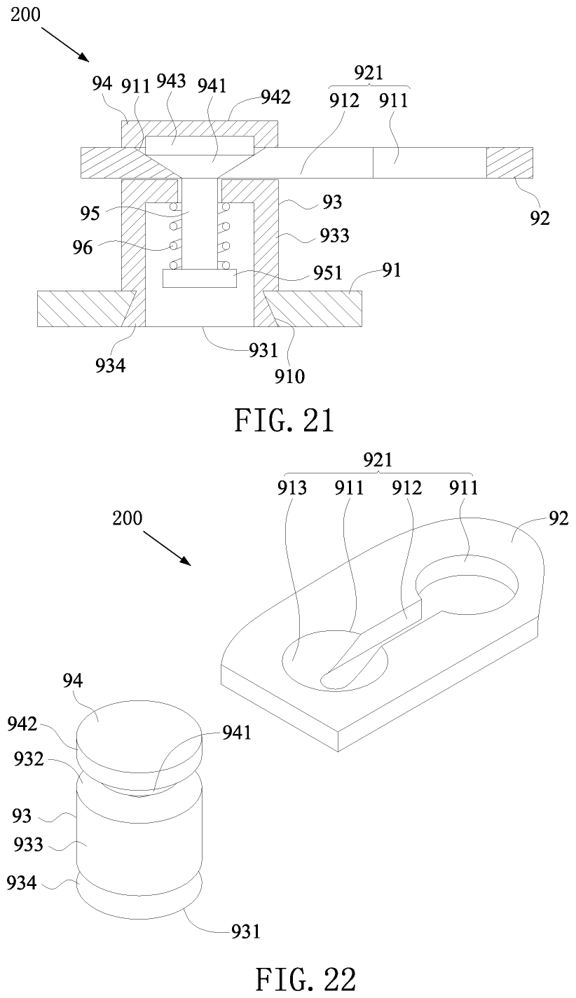

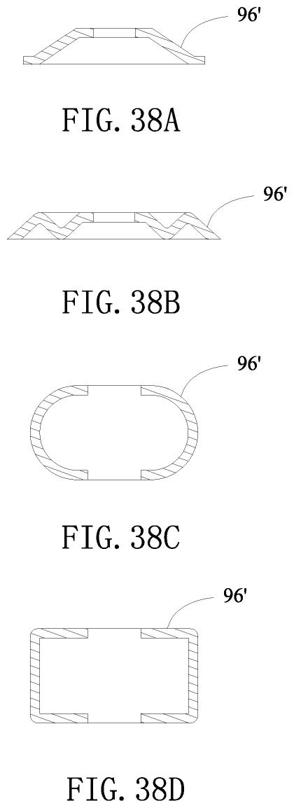

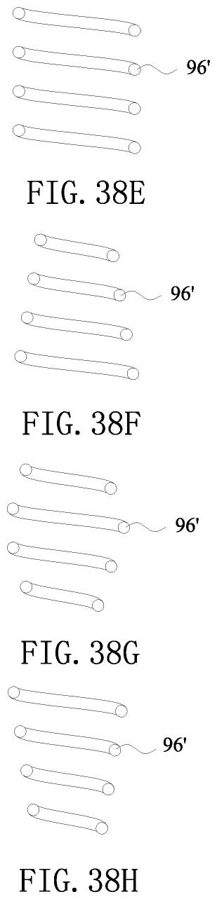

As shown in FIG. 15, the body 93 may be a hollow sleeve 933. A first end of the sleeve 933 is provided with an assembly portion 934, such that the assembly portion 934 is for connecting on a fixing hole 910 of the first object 91 (as shown in FIG. 16), with the connecting structure thereof being any connecting structure such as a welding structure (as shown in FIG. 17A or FIG. 38C), an engaging structure (as shown in FIG. 20A), a rivet structure (as shown in FIG. 21), a screw lock connection structure (as shown in FIG. 26), a expansion connection structure (as shown in FIG. 26), an adhesion structure (not shown) or a magnetic structure (not shown). The engaging head 94 and the neck 95 may be a component formed as an integral (as shown in FIG. 15) or be formed as an assembly (as shown in FIG. 18). For example, the part of the neck 95 protruding from the body 93 (the sleeve 933) is partially or entirely a formed integral or a formed assembly with the engaging head 94 (as shown in FIG. 18), such that one end of the neck 95 is movably inserted in the sleeve 933 and the engaging head 94 is located on a second end 932 of the body 93 (the sleeve 933), and the stop portion 951 on one end and the neck 95 can be a formed as an integral (as shown in FIG. 15) or a formed as an assembly (as shown in FIG. 18). Moreover, the elastic element 96 is preferably a spiral spring, an elastic piece, a cylindrical elastic body or other elastic bodies, and the elastic element 96 is sleeved at the neck 95 in the sleeve 933, further providing fastening and shock absorbing functions between the engaging head 94 and the second end 932 of the body 93. In addition, the elastic element 96 may be made of a metal, plastic, rubber or silicone material.

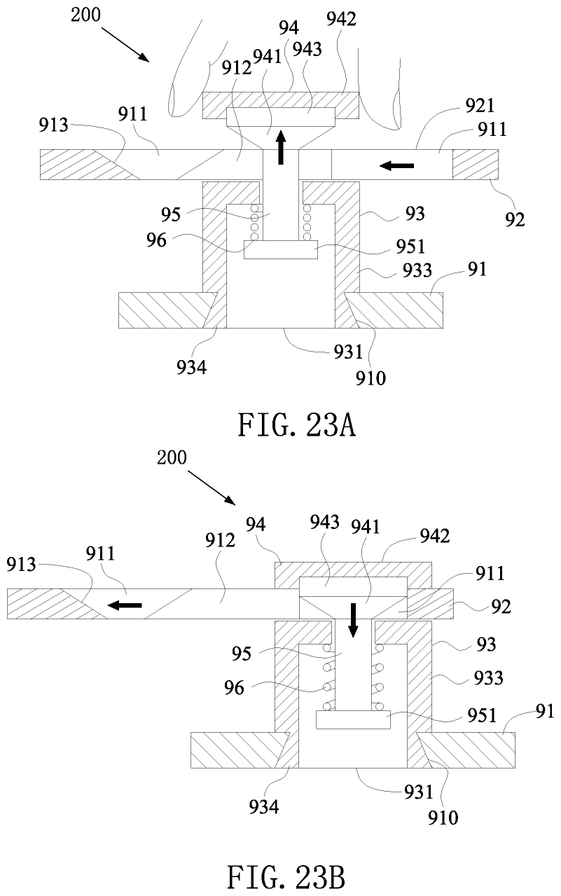

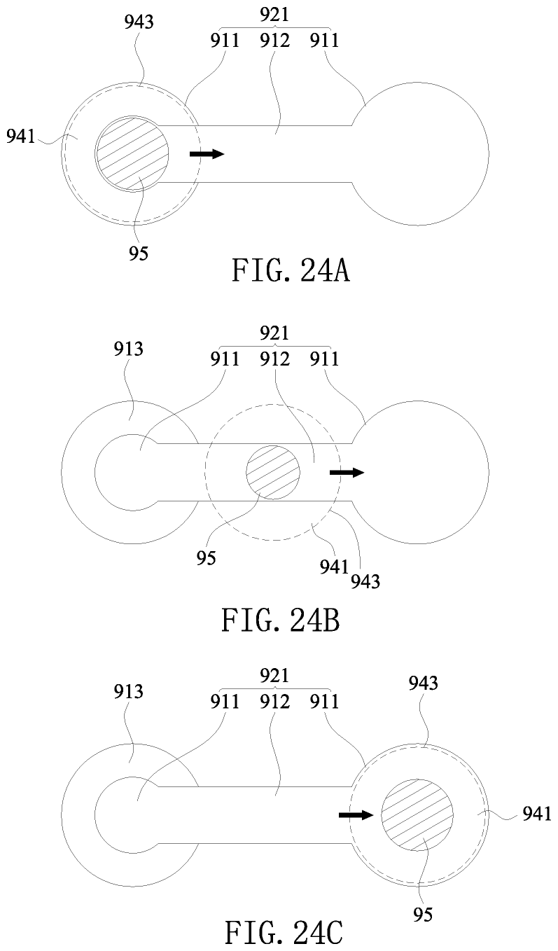

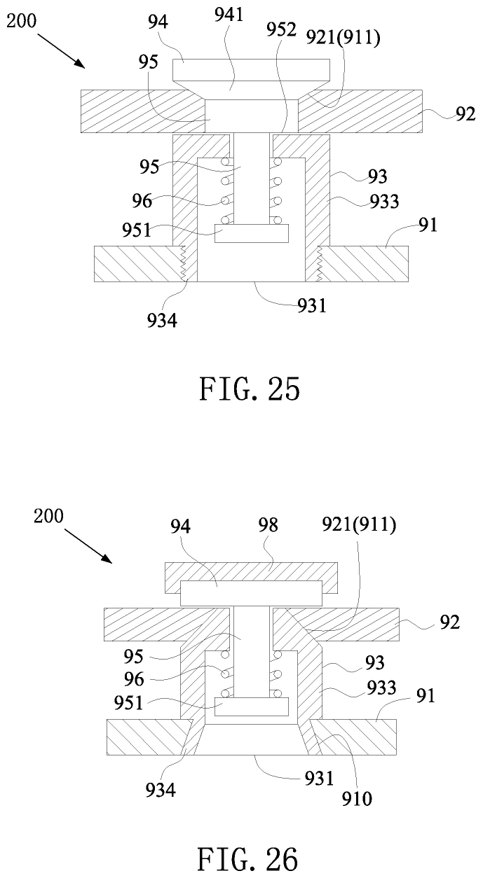

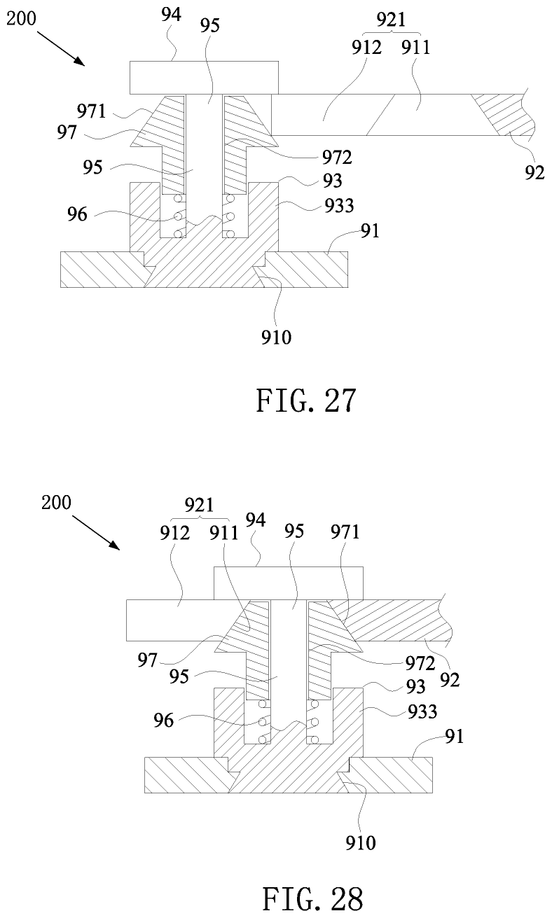

Again as shown in FIG. 15 and FIG. 16, a first sloped guide surface 935 corresponding to the second object 92 may be implemented around the second end 932 of the body 93 (the sleeve 933), such that the second end 932 is tapered. Once the neck 95 moves to a predetermined position in the slide opening 921 of the second object 92 (as shown in FIG. 17A and FIG. 17B), the first sloped guide surface 935 can facilitate the second object 92 to be pushed, positioned and fastened in the slide opening 921 of the second object 92. Again as shown in FIG. 17 and FIG. 18, a second sloped guide surface 941 corresponding to the second object 92 may be implemented at the engaging head 94, such that one surface of the engaging head 94 is tapered. Once the neck 95 moves to a predetermined position in the slide opening 921 of the second object 92 (as shown in FIG. 20A and FIG. 20B), the second sloped guide surface 941 can facilitate the second object 92 to be pushed, positioned and fastened in the slide opening 921 of the second object 92. Again as shown in FIG. 20 and FIG. 21, the engaging head 94 may be implemented with an operating portion 942 for pulling, a stop protrusion 943 located on one surface of the operating portion 942 and corresponding to the second object 92, and a second sloped guide surface 941 located at the stop protrusion 943, such that the stop protrusion 943 corresponds to one end of the second object 92 and is tapered. The operating portion 942 may be a cap and have an outer diameter greater than that of an opening portion 911 to allow the operating portion 942 to be stopped outside the opening portion 911. The stop protrusion 943 may be a cylinder. The operating portion 942 and the stop protrusion 943 may be a formed as an integral or formed as an assembly. The second sloped guide surface 941 facilitates the second object 92 to be pushed, and once the neck 95 moves and positions to the opening portion 911 that is directly in communication in the slide opening 921 of the second object 92 (as shown in FIG. 23A and FIG. 23B, and FIG. 24A to FIG. 24C), allows the stop protrusion 943 and the second sloped guide surface 941 to be positioned and fastened in the opening portion 911 that is directly in communication in the slide opening 921 of the second object 92. At this point, an outer wall of the stop protrusion 943 is limited by an inner wall of the opening portion 911 that is directly in communication, thus achieving the effect of engaging. As shown in FIG. 25, the neck 95 may also be implemented with a shoulder 952 having a greater diameter, and the shoulder 952 is formed as an integral or an assembly at the engaging head 94. With the shoulder 952 pressing against the second end 932 of the body 93 (the sleeve 933), the engaging head 94 is kept from the body 93 by a gap, so as to facilitate sliding and fastening of the second object 92. Moreover, the neck 95 and the body 93 may also be implemented as an integrally formed structure (as shown in FIG. 27 and FIG. 28), or as the structure formed with an inserted assembly above.

As shown in FIG. 17A and FIG. 17B, the slide opening 921 of the second object 92 preferably includes an opening portion 911 and a slide slot 912 in communication with the opening portion 911. The opening portion 911 may be a hole having a wall surface perpendicularly in communication with a surface of the second object 92. Thus, once the neck 95 in the sliding slot 912 moves to the opening portion 911, with the effect of the elastic element 96, the engaging head 94 and the body 93 are fastened in the opening portion 911. As shown in FIG. 22 and

FIG. 24A to FIG. 24C, the slide opening 921 of the second object 92 may be implemented as two or more opening portions 911, and a slide slot 912 in communication with each of the opening portions 911. Thus, once the neck 95 in the slide slot 912 moves to the opening portion 911, the engaging head 94 and the body 93 are fastened in either of the opening portion 911. As shown in FIG. 19, FIG. 20A and FIG. 22, the opening portion 911 of the slide opening 921 is preferably implemented with a guide sloped surface 913 such that the opening portion 911 is formed as a tapered hole. Thus, the first sloped guide surface 935 and the second sloped guide surface 941 form precise positioning and fastening via the guide sloped surface 913. As shown in FIG. 19, the engaging head 94 enters the slide slot 912 after being placed in the opening portion 911, so that the neck 95 acts in the slide slot 912 via the elastic element 96 to fasten the engaging head 94 and the body 93 in the slide slot 912.

As shown in FIG. 27 and FIG. 28, in one embodiment, the fastener 200 may include: a body 93, a first end 931 of the body 93 being integrally formed or assembled on a first object 91; a pressing member 97 movably disposed on a second end 932 of the body 93; an engaging head 94 movably disposed on one end of the pressing member 97, the engaging head 94 including a neck 95, the neck 95 passing through the pressing member 97 and disposed in the body 93, so such that the neck 95 is for moving in a slide opening 921 of a second object 92; and an elastic element 96 disposed around the neck 95 such that one end of the elastic element 96 presses against the pressing member 97 and the other end presses against the body 93 on one end of the neck 95. Thus, as shown in FIG. 27, when the body 93 is coupled on the first object 91, the neck 95 is movable in the slide opening 921 of the second object 92. When the neck 95 moves to a predetermined position, as shown in FIG. 27, with the effect of the elastic element 96, the engaging head 94 and the pressing member 97 are fastened in the slide opening 921 of the second object 92, further forming a structure for engaging the second object 92 and providing shock absorption.

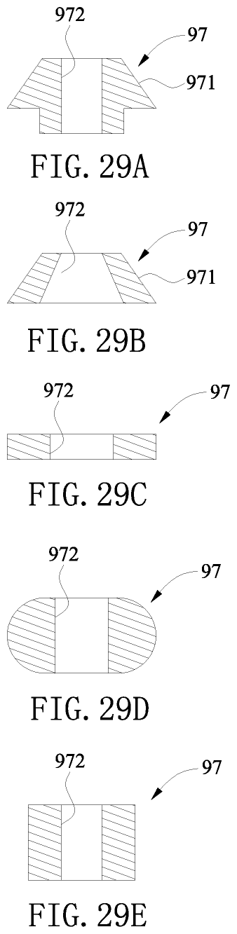

In this embodiment, the pressing member 97 may be implemented with a third sloped guide surface 971 corresponding to the second object 92 such that one end of the pressing member 97 is tapered. Once the neck 95 moves in the slide slot 912 of the slide opening 921 (as shown in FIG. 27) to the opening portion 911, the third sloped guide surface 971 is fastened in the opening portion 911 of the slide opening 921 (as shown in FIG. 28). The structure of the pressing member 97 may be implemented as a cone (as shown in FIG. 29A and FIG. 29B), a plate (as shown in FIG. 29C), a sphere (as shown in FIG. 29D), an ellipsoid or a column (as shown in FIG. 29E) having a through hole 972, so as to allow the neck 95 to pass through the through hole 972 to further form a fastener for engaging and providing shock absorption. It should be noted that, in this embodiment, the implementation details of the first object 91, the second object 92, the slide opening 921 and the body 93 may be referred from the drawings and the description associated with the embodiments above, and are not repeated herein.

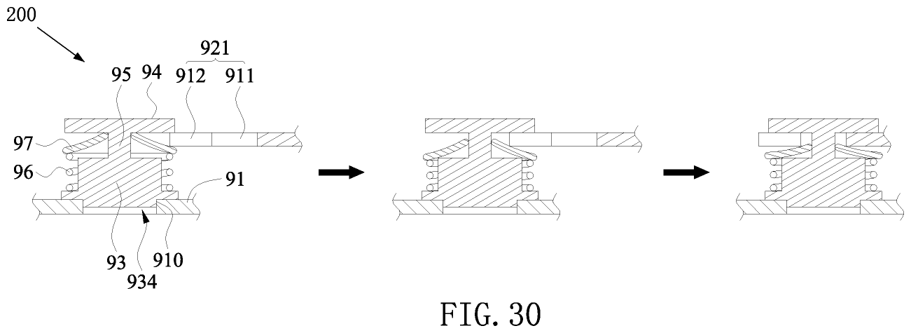

Referring to FIG. 30, the fastener 200 differs from the fastener 200 in FIG. 26 and FIG. 27 in that, the other end of the elastic element 96 in FIG. 26 and FIG. 27 presses inside the body 93, and the other end of the elastic element 96 of the column structure for engaging and providing shock absorption in FIG. 29 presses outside the body 93. It should be noted that, in FIG. 30, the implementation details of the first object 91, the second object 92, the slide opening 921 and the body 93 may be referred from the drawings and the description associated with the embodiments above, and are not further described herein.

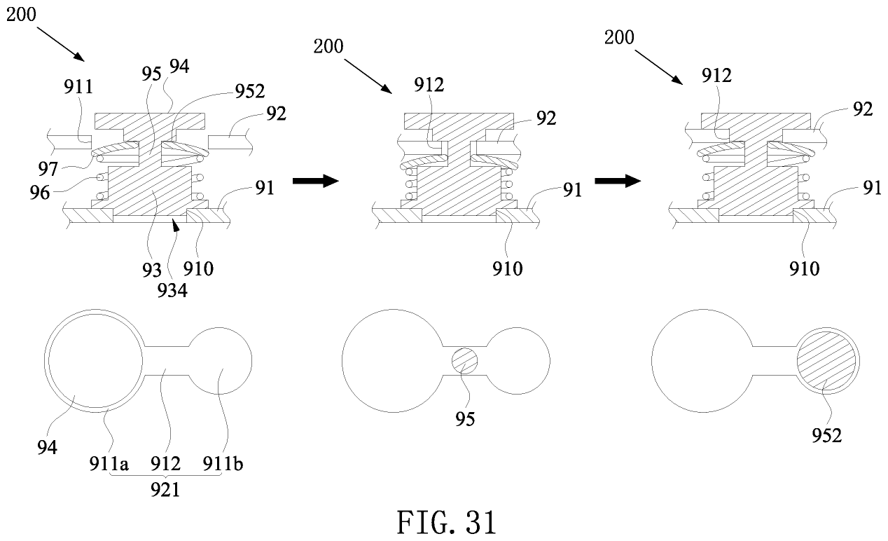

Referring to FIG. 31, the fastener 200 differs from the fastener 200 in FIG. 29 in that, a shoulder 952 exists between the neck 95 and the engaging head 94 in FIG. 31, and the pressing member 97 in FIG. 31 presses below the shoulder 952, whereas the pressing member 97 in FIG. 30 presses below the engaging head 94. The second object 92 in FIG. 31 includes a large opening portion 911a, a slide slot 912 and a slide opening 921 of a small opening portion 911b. To put application, the large opening portion 911a is sleeved at below the engaging head 94, and the slide slot 912 is slid. At this point, since the width of the slide slot 912 is greater than that of the neck 95 and smaller than that of the shoulder 952, the slide slot 912 is located at the neck 95 and is slidably sandwiched between the shoulder 952 and the elastic element 96. Then, the small opening portion 911b is slid. At this point, since the small opening portion 911b is greater than that of the shoulder 952 and smaller than that of the engaging head 94, the small opening 911b is located at the shoulder 952 and is engaged between the engaging head 94 and the elastic element 96.

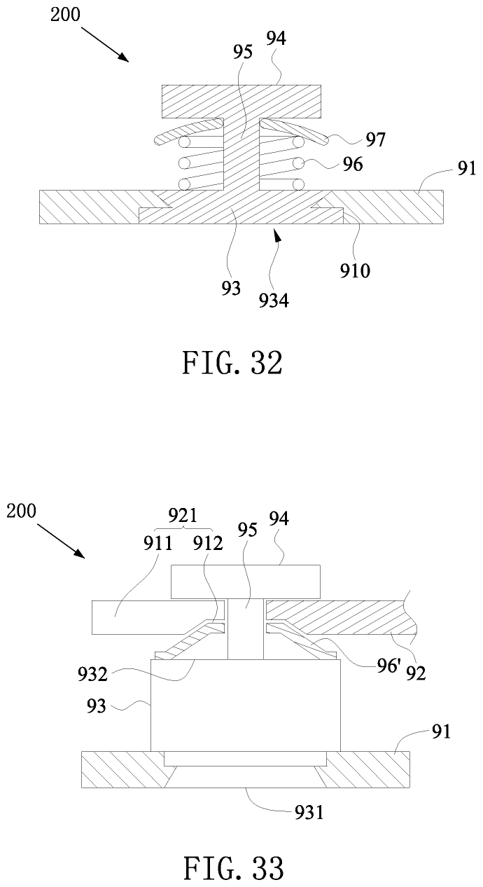

Referring to FIG. 32, the fastener 200 differs from the fastener 200 in FIG. 30 in that, the body 93 in FIG. 32 is flat shaped, and the other end of the elastic element 96 in FIG. 32 presses above the body 93, whereas the other end of the elastic element 96 presses outside the body 93. It should be noted that, in FIG. 31, the implementation details of the first object 91, the second object 92, the slide opening 921 and the body 93 may be referred from the drawings and the description associated with the embodiments above, and are not repeated herein.

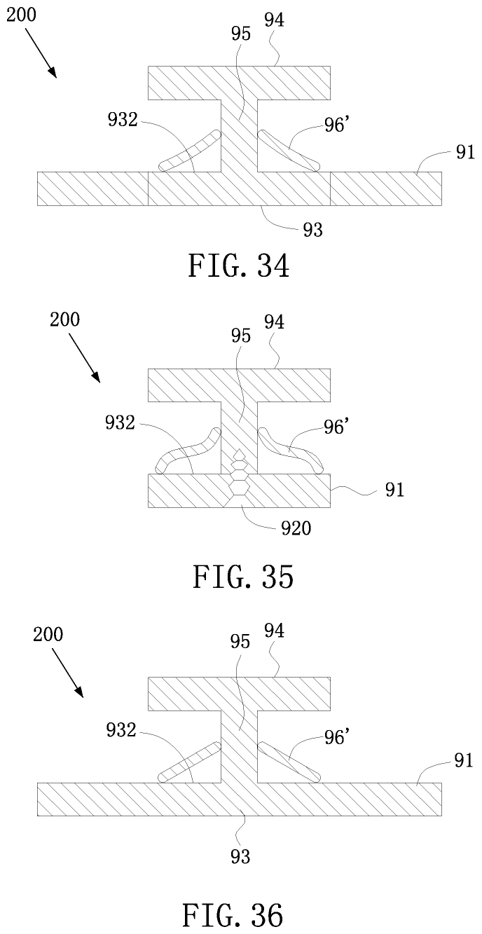

Referring to FIG. 33, in one embodiment, the fastener 200 includes: a body 93, a first end 931 of the body 93 being integrally formed (as shown in FIG. 35) or assembled on a first object 91; an engaging head 94 movably, fixedly or integrally (as shown in FIG. 34) disposed on a second end 932 of the body 93, the engaging head 94 including a neck 95, the neck 95 integrally formed or movably or fixedly disposed on the body 93, or the neck 95 movably disposed on the body 93 and not being exposed outside the first end 931 of the body 93 or outside the first object 91, such that the neck 95 is for moving in a slide opening 921 of a second object 92; and an elastic element 96′ movably disposed around the neck 95 on a second end 932 of the body 93. Thus, the engaging head 94 and the elastic element 96′ can be fastened in the slide opening 921 of the second object 92 to further form a structure for engaging the second object 92 and providing shock absorption.

In this embodiment, the implementation of the body 93 is optional, and the neck 95 may be fixed on the first object 91 (as shown in FIG. 35) via a connecting member 920 (for example, a screw). Alternatively, the neck 95 is integrally formed on the first object 91.

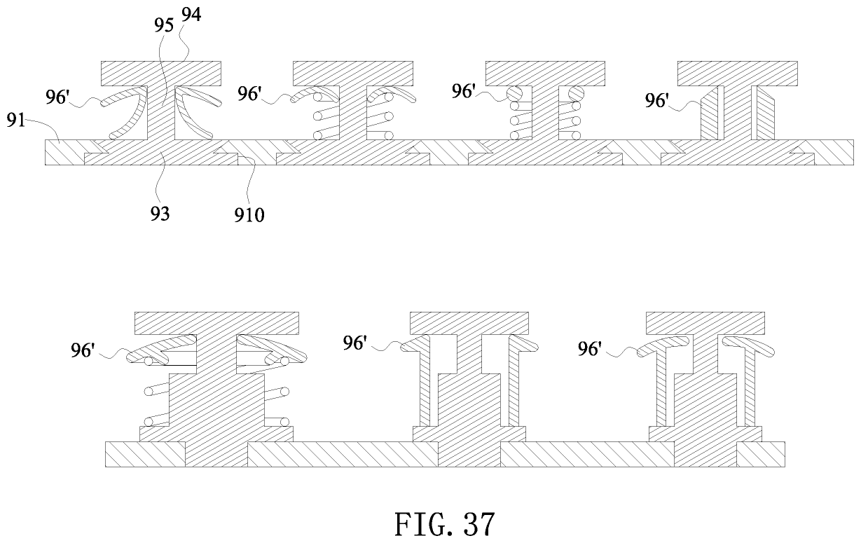

In this embodiment, as shown in FIG. 37, the elastic element 96′ may also be implemented as various types of hollow elastic bodies.

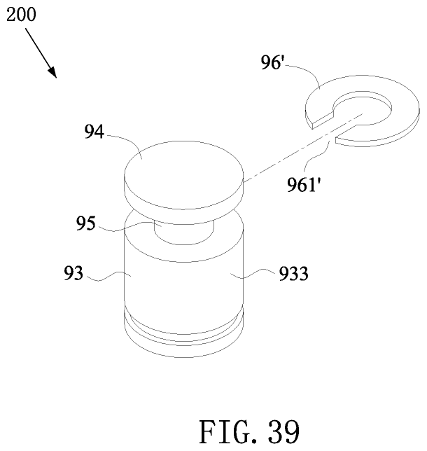

In this embodiment, the elastic element 96′ may also be implemented as a cone (as shown in FIG. 33 and FIG. 38A), a concave-convex plate (as shown in FIG. 38B), a sphere (as shown in FIG. 38C), an ellipsoid, a column (as shown in FIG. 38D) or a spiral thread (as shown in FIG. 38E to 38H) that is hollow. Thus, the neck 95 is caused to pass through the elastic element 96′, and once the neck 95 in the slide slot 912 of the slide opening 921 moves to the opening portion 911, the elastic element 96′ is fastened in the opening portion 911 of the slide opening 921 (as shown in FIG. 20). In this embodiment, the elastic element 96′ may be implemented with a notch 961′ (as shown in FIG. 39) for corresponding receiving or being inserted with the neck 95, so as to facilitate assembly of the elastic element 96′ and the neck 95.

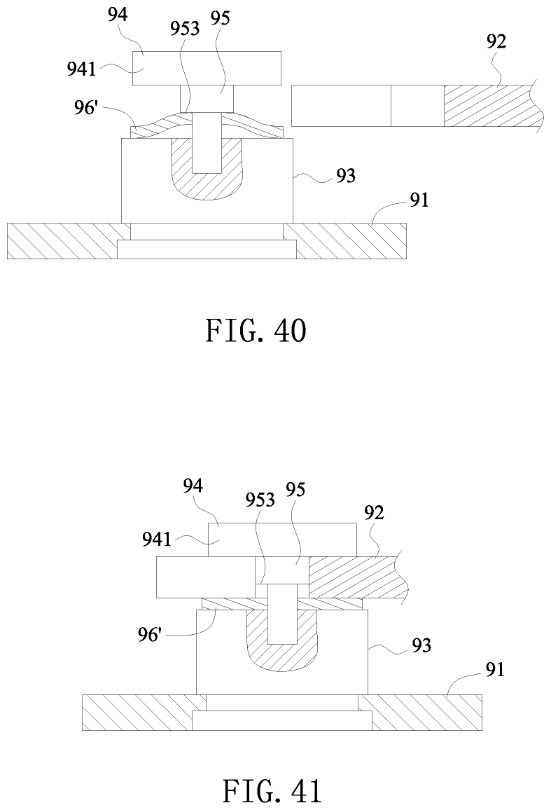

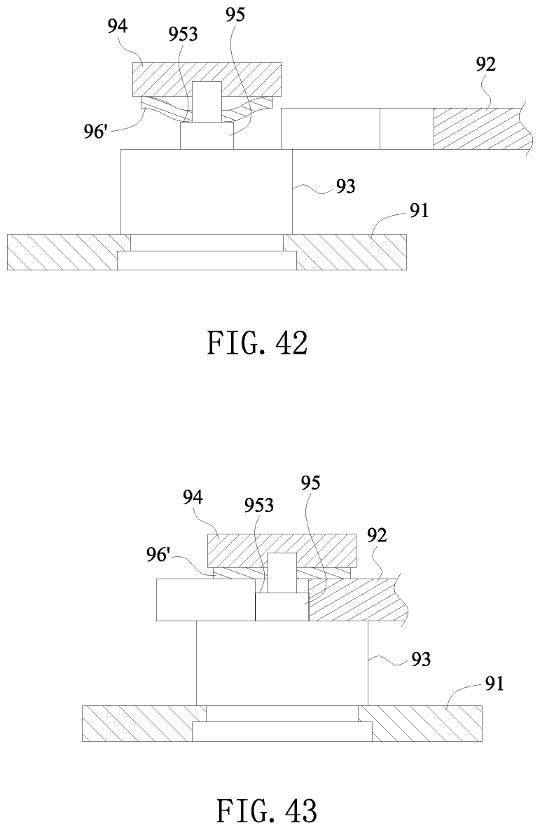

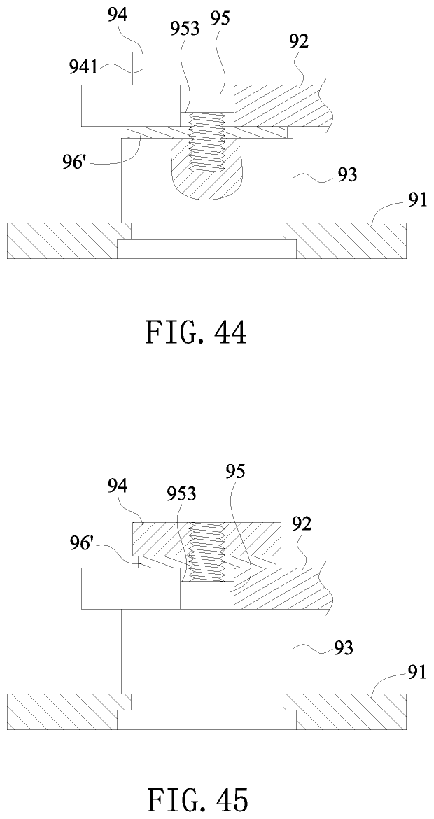

Moreover, in this embodiment, the neck 95 may be implemented with a second shoulder 953 having a larger diameter (as shown in FIG. 39 or FIG. 42), wherein the height of the second shoulder 953 is smaller than the thickness of the second object 92, so as to limit or press one end of the elastic element 96′ at the second shoulder 953. Thus, the elastic element 96′ is limited and does not wobble up and down. When the second object 92 is received in the neck 95, the elastic element 96′ again presses the second object 92 (as shown in FIG. 41 or FIG. 43). In addition, the specific position of the second shoulder 953 may be implemented on one end close to the engaging head 94 (as shown in FIGS. 40 and 41), or on the other end opposite to the engaging head 94 (as shown in FIGS. 42 and 43). In this embodiment, one end of the neck 95 may also be assembled with the body 93 via a screw structure (as shown in FIG. 44), and the other end of the neck 95 may also be specifically assembled with the engaging head 94 via a screw structure (as shown in FIG. 45).

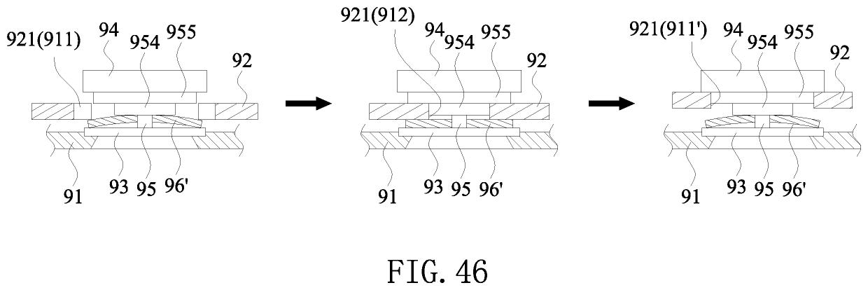

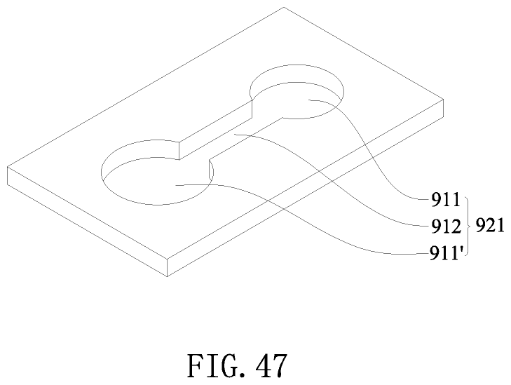

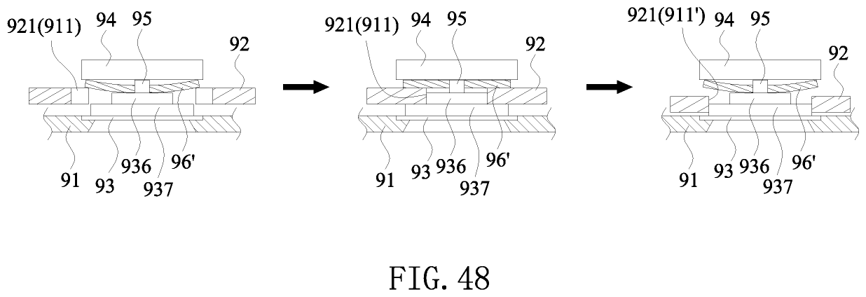

Moreover, as shown in FIG. 46, a first stop portion 954 having a larger diameter and a second stop portion 955 may be implemented at the neck 95 on one end close to the engaging head 94, such that the neck 95, the first stop portion 954 and the second stop portion 955 form stepped columns, and one end of the elastic element 96′ is limited or pressed at the first stop portion 954. As shown in FIG. 47, the slide opening 921 of the second object 92 above may be implemented with two opening portions 911 and 911′, and a slide slot 912 in communication with the opening portions 911 and 911′. The width of the slide slot 912 matches the first stop portion 954, the diameter of one opening portion 911 is greater than that of the engaging head 94, and the diameter of the other opening portion 911′ matches the second stop portion 955. Thus, when the neck 95 slides from one opening portion 911 of the second object 92 to the other opening portion 911′, the first stop portion 954 may pass through the slide slot 912 to arrive at the other opening portion 911′, and the second object 92 is pressed by the elastic element 96′ such that the second stop portion 955 is matchingly engaged at the opening portion 911′. Moreover, as shown in FIG. 48, the body 93 may also be implemented with the first stop portion 936 and a second stop portion 937 above, such that one end of the elastic element 96′ is limited or pressed at the first stop portion 936, thus further achieving the same function and effect.

Further, as shown in FIG. 26, a top end of the engaging head 94 may be further implemented with a colored sleeve 98. The colored sleeve 98 may be formed at the engaging head 94 by means of painting, plastic injection, adhesion, dyeing, coating or electroplating.

The present disclosure is described by way of the preferred embodiments above. A person skilled in the art should understand that, these embodiments are merely for describing the present disclosure and are not to be construed as limitations to the scope of the present disclosure. It should be noted that all equivalent changes, replacements and substitutions made to the embodiments are to be encompassed within the scope of the present disclosure. Therefore, the scope of protection of the present disclosure should be accorded with the interpretation of the appended claims.

What is claimed is:

1. A rod structure used in an electronic device, comprising:
an engaging rod, comprising a rod, the rod comprising an assembly portion and a push portion, the assembly portion movably assembled at an assembled object, and the push portion for pushing a pushed object; and
a fastener, for engaging the engaging rod at an engaged object, wherein when the fastener is engaged with or disengaged from the engaged object, the engaging rod is for causing the push portion to push against the pushed object.

2. A rod structure used in an electronic device, comprising:
an engaging rod, comprising a rod, the rod comprising an assembly portion, the assembly portion movably assembled at an assembled object; and
a fastener, for engaging the engaging rod at an engaged object.

3. The rod structure used in the electronic device according to claim 1, wherein the fastener comprises an engaging portion, a body, a trigger portion and an elastic element; the engaging portion is for engaging at a counterpart engaging portion of the engaged object, the body is for assembling at a rod of the engaging rod, the trigger portion is located at the body, the engaging portion passes through the body and is movably assembled at the trigger portion, the elastic element is disposed between the engaging portion and the body, the trigger portion is for being triggered to prompt the engaging portion to be elastically moved or moved up and down in the body; alternatively, the engaging portion comprises a head, and the head is for elastically sandwiching or engaging the counterpart engaging portion of the engaged object via an elastic force of the elastic element.

4. The rod structure used in the electronic device according to claim 2, wherein the fastener comprises an engaging portion, a body, a trigger portion and an elastic element; the engaging portion is for engaging at a counterpart engaging portion of the engaged object, the body is for assembling at a rod of the engaging rod, the trigger portion is located at the body, the engaging portion passes through the body and is movably assembled at the trigger portion, the elastic element is disposed between the engaging portion and the body, the trigger portion is for being triggered to prompt the engaging portion to be elastically moved or moved up and down in the body; alternatively, the engaging portion comprises a head, and the head is for elastically sandwiching or engaging the counterpart engaging portion of the engaged object via an elastic force of the elastic element.

5. The rod structure used in the electronic device according to claim 3, wherein the trigger portion and the engaging portion are assembled by a pivotal connection in between, and the trigger portion is for being triggered between an engaging state and a lifted state; in the engaging state, the engaging portion is engaged at the counterpart engaging portion of the object, the trigger portion is movably assembled at an engaging height between a pivotal portion of the engaging portion and the body; in the lifted state, the engaging portion is disengaged from the counterpart engaging portion of the object, and a lifted height exists between the pivotal portion and the body so as to perform an effort-saving push motion between high and low positions.

6. The rod structure used in the electronic device according to claim 4, wherein the trigger portion and the engaging portion are assembled by a pivotal connection in between, and the trigger portion is for being triggered between an engaging state and a lifted state; in the engaging state, the engaging portion is engaged at the counterpart engaging portion of the object, the trigger portion is movably assembled at an engaging height between a pivotal portion of the engaging portion and the body; in the lifted state, the engaging portion is disengaged from the counterpart engaging portion of the object, and a lifted height exists between the pivotal portion and the body so as to perform an effort-saving push motion between high and low positions.

7. The rod structure used in the electronic device according to claim 1, wherein the fastener comprises:
a head, comprising a shaft, a stop portion and a fitting portion;
a body, for assembling at the engaged object and comprising a corresponding stop portion, the corresponding stop portion movably assembled with the stop portion; and
an elastic element, having one end pressing against the stop portion and one other end pressing against the body to prompt the head to move elastically;
wherein a width of the fitting portion is greater than a receiving portion of the engaged object, and a width of the body is smaller than the receiving portion, such that the body is allowed to enter the receiving portion to fit the fitting portion at the receiving portion.

8. The rod structure used in the electronic device according to claim 2, wherein the fastener comprises:
a head, comprising a shaft, a stop portion and a fitting portion;
a body, for assembling at the engaged object and comprising a corresponding stop portion, the corresponding stop portion movably assembled with the stop portion; and
an elastic element, having one end pressing against the stop portion and one other end pressing against the body to prompt the head to move elastically;
wherein a width of the fitting portion is greater than a receiving portion of the engaged object, and a width of the body is smaller than the receiving portion, such that the body is allowed to enter the receiving portion to fit the fitting portion at the receiving portion.

9. The rod structure used in the electronic device according to claim 7, wherein the head further comprises an accommodating portion, the body is accommodated in the accommodating portion to reduce a structural height of the fastener; alternatively, the fitting portion comprises a guide portion, the guide portion is a sloped surface, a curved surface, an arched surface, a stepped portion or a tiered portion for guiding or pressing the head to enter the receiving portion of the object or to enter an engaging portion or a receiving portion, and a force is applied on the engaging portion or the receiving portion, such that the guide portion lifts the head to depart from the engaging portion or the receiving portion, and to enter the receiving portion or depart from the engaged portion; alternatively, the fitting portion is a sloped surface, a curved surface, an arched surface or a stepped portion and is for being received in a receiving portion of an engaged object, or is for first being received in a receiving portion of an engaged object and then engaged at an engaging portion of the engaged object; alternatively, the fitting portion is a fixed limiting portion, and is for passing through above a receiving portion of an engaged object and being engaged at an engaging portion of the engaged object, so as to fix, stop and limit the fitting portion at the engaging portion.

10. The rod structure used in the electronic device according to claim 8, wherein the head further comprises an accommodating portion, the body is accommodated in the accommodating portion to reduce a structural height of the fastener; alternatively, the fitting portion comprises a guide portion, the guide portion is a sloped surface, a curved surface, an arched surface, a stepped portion or a tiered portion for guiding or pressing the head to enter the receiving portion of the object or to enter an engaging portion or a receiving portion, and a force is applied on the engaging portion or the receiving portion, such that the guide portion lifts the head to depart from the engaging portion or the receiving portion, and to enter the receiving portion or depart from the engaged portion; alternatively, the fitting portion is a sloped surface, a curved surface, an arched surface or a stepped portion and is for being received in a receiving portion of an engaged object, or is for first being received in a receiving portion of an engaged object and then engaged at an engaging portion of the engaged object; alternatively, the fitting portion is a fixed limiting portion, and is for passing through above a receiving portion of an engaged object and being engaged at an engaging portion of the engaged object, so as to fix, stop and limit the fitting portion at the engaging portion.

11. The rod structure used in the electronic device according to claim 1, wherein the engaging portion is for coupling at the engaging rod, the fastener is slidable at a second object to be further fastened at a slide opening of the second object, the fastener comprises:
a body, for being integrally formed or assembled at the engaging rod;
an engaging head movably disposed at the body, the engaging head comprising a neck, the neck movably disposed at the body, the neck for moving in the slide opening of the second object; and
an elastic element, movably disposed around the neck and pressing against the body;
wherein, the engaging head and the body are for fastening at the slide opening of the second object.

12. The rod structure used in the electronic device according to claim 2, wherein the engaging portion is for coupling at the engaging rod, the fastener is slidable at a second object to be further fastened at a slide opening of the second object, the fastener comprises:
a body, for being integrally formed or assembled at the engaging rod;
an engaging head movably disposed at the body, the engaging head comprising a neck, the neck movably disposed at the body, the neck for moving in the slide opening of the second object; and
an elastic element, movably disposed around the neck and pressing against the body;
wherein, the engaging head and the body are for fastening at the slide opening of the second object.

13. The rod structure used in the electronic device according to claim 1, wherein the engaging portion is for coupling at an engaging rod, the fastener is slidable at a second object so as to be further fastened at a slide opening of the second object, the fastener comprises:
a body, for being integrally formed or assembled at the engaging rod;
a pressing member movably disposed at the body; and
an engaging head movably disposed at the pressing member, the engaging head comprising a neck, the neck passing through the pressing member and disposed at the body, the neck for moving in the slide opening of the second object; and an elastic element, disposed around the neck and pressing against the pressing member;
wherein, the engaging head and the pressing member are for fastening at the slide opening of the second object.

14. The rod structure used in the electronic device according to claim 2, wherein the engaging portion is for coupling at an engaging rod, the fastener is slidable at a second object so as to be further fastened at a slide opening of the second object, the fastener comprises:
a body, for being integrally formed or assembled at the engaging rod;
a pressing member movably disposed at the body; and
an engaging head movably disposed at the pressing member, the engaging head comprising a neck, the neck passing through the pressing member and disposed at the body, the neck for moving in the slide opening of the second object; and an elastic element, disposed around the neck and pressing against the pressing member;
wherein, the engaging head and the pressing member are for fastening at the slide opening of the second object.

15. The rod structure used in the electronic device according to claim 1, wherein the engaging portion is for coupling at an engaging rod, the fastener is slidable at a second object so as to be further fastened at a slide opening of the second object, the fastener comprises:
a body, for being integrally formed or assembled at the engaging rod;
an engaging head movably or fixedly disposed or integrally formed at the body, the engaging head comprising a neck, the neck movably or fixed disposed or integrally formed at the body, the neck for moving in the slide opening of the second object; and
an elastic element, movably disposed around the neck of the body;
wherein, the engaging head and the elastic element are for fastened at the slide opening of the second object.

16. The rod structure used in the electronic device according to claim 2, wherein the engaging portion is for coupling at an engaging rod, the fastener is slidable at a second object so as to be further fastened at a slide opening of the second object, the fastener comprises:
a body, for being integrally formed or assembled at the engaging rod;
an engaging head movably or fixedly disposed or integrally formed at the body, the engaging head comprising a neck, the neck movably or fixed disposed or integrally formed at the body, the neck for moving in the slide opening of the second object; and
an elastic element, movably disposed around the neck of the body;
wherein, the engaging head and the elastic element are for fastened at the slide opening of the second object.

17. The rod structure used in the electronic device according to claim 11, further comprising one or more column structures, the column structure for forming with the engaged object a module for engaging the second object, the column structure being a plate, a sheet, a block, a strip or a polygon body.

18. The rod structure used in the electronic device according to claim 12, further comprising one or more column structures, the column structure for forming with the engaged object a module for engaging the second object, the column structure being a plate, a sheet, a block, a strip or a polygon body.

19. The rod structure used in the electronic device according to claim 13, further comprising one or more column structures, the column structure for forming with the engaged object a module for engaging the second object, the column structure being a plate, a sheet, a block, a strip or a polygon body.

20. The rod structure used in the electronic device according to claim 14, further comprising one or more column structures, the column structure for forming with the engaged object a module for engaging the second object, the column structure being a plate, a sheet, a block, a strip or a polygon body.

21. The rod structure used in the electronic device according to claim 15, further comprising one or more column structures, the column structure for forming with the engaged object a module for engaging the second object, the column structure being a plate, a sheet, a block, a strip or a polygon body.

22. The rod structure used in the electronic device according to claim 16, further comprising one or more column structures, the column structure for forming with the engaged object a module for engaging the second object, the column structure being a plate, a sheet, a block, a strip or a polygon body.

23. The rod structure used in the electronic device according to claim 1, wherein the fastener comprises an engaging portion, a head and an elastic element; the engaging portion is for engaging at a counterpart engaging portion of the engaged object, the body is for assembling at a rod of the engaging rod, the elastic element is disposed between the engaging portion and the body, and the engaging portion is a sphere and is received at the counterpart engaging portion of the engaged object via an elastic force of the elastic element; alternatively, the fastener further comprises an actuating member, the actuating member comprises a slide portion, the engaging portion comprises a corresponding slide portion corresponding to the slide portion, the elastic element is disposed between the engaging portion and the body, and the actuating member is for being moved to prompt the corresponding slide portion to slide relative to the slide portion, so as to elastically move the engaging portion via an elastic force of the elastic element.

24. The rod structure used in the electronic device according to claim 2, wherein the fastener comprises an engaging portion, a head and an elastic element; the engaging portion is for engaging at a counterpart engaging portion of the engaged object, the body is for assembling at a rod of the engaging rod, the elastic element is disposed between the engaging portion and the body, and the engaging portion is a sphere and is received at the counterpart engaging portion of the engaged object via an elastic force of the elastic element; alternatively, the fastener further comprises an actuating member, the actuating member comprises a slide portion, the engaging portion comprises a corresponding slide portion corresponding to the slide portion, the elastic element is disposed between the engaging portion and the body, and the actuating member is for being moved to prompt the corresponding slide portion to slide relative to the slide portion, so as to elastically move the engaging portion via an elastic force of the elastic element.

25. The rod structure used in the electronic device according to claim 1, wherein a first connector is provided on one side of the assembled object, the push portion pushes the pushed object and is for moving the assembled object toward a connected object, such that the first connector is connected to a second connector of the connected object; alternatively, the push portion pushes the pushed object to move the assembled object away from the connected object, such that the first connector departs from the second connector.

26. The rod structure used in the electronic device according to claim 1, wherein the fastener comprises:
a head, comprising a shaft and an assembly portion;
wherein the engaged object comprises a counterpart engaging portion, a width of the assembly portion of the head is greater than that of the counterpart engaging portion, and a width of the shaft is smaller than that of the counterpart engaging portion, so that the shaft is allowed to enter the counterpart engaging portion to engage the assembly portion at the counterpart engaging portion; alternatively
the fastener comprises an actuating member, an engaging portion and a body, the actuating member comprises a slide portion, the engaging portion comprises a corresponding slide portion corresponding to the slide portion, and the actuating portion is for being moved to prompt the corresponding slide portion to slide relative to the slide portion so as to move the engaging portion.

27. The rod structure used in the electronic device according to claim 2, wherein the fastener comprises:
a head, comprising a shaft and an assembly portion;
wherein the engaged object comprises a counterpart engaging portion, a width of the assembly portion of the head is greater than that of the counterpart engaging portion, and a width of the shaft is smaller than that of the counterpart engaging portion, so that the shaft is allowed to enter the counterpart engaging portion to engage the assembly portion at the counterpart engaging portion; alternatively
the fastener comprises an actuating member, an engaging portion and a body, the actuating member comprises a slide portion, the engaging portion comprises a corresponding slide portion corresponding to the slide portion, and the actuating portion is for being moved to prompt the corresponding slide portion to slide relative to the slide portion so as to move the engaging portion.
